(19) United States
(12) Patent Application Publication
(10) Pub. No.: US 2006/0255733 A1
(43) Pub. Date: Nov. 16, 2006

(54) Plasma display panel

(76) Inventor: Eui Jeong Hwang, Youngin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/414,277

(22) Filed: Apr. 27, 2006

(30) Foreign Application Priority Data
May 10, 2005 (KR) 10-2005-0038963

(51) Int. Cl. H01J 17/02

(52) U.S. Cl. 313/609

(57) ABSTRACT

A plasma display panel having improved sealing performance and connectivity to external devices is disclosed. The plasma display panel includes a front panel, a rear panel, an intermediate member interposed between the front and the rear panels, sealants for sealing spaces formed between the front and rear panels, and address and sustain electrodes crossing each other. The intermediate member includes at least one dielectric layer. The dielectric layer includes a plurality of first directional components, a plurality of second directional components crossing the first directional components, and an edge part surrounding the first and second directional components. The sealant is aligned on the edge part when viewed from a direction perpendicular to the plasma display panel. The intermediate member may include a plurality of dielectric layers, the edge parts of which have widths different from each other.

### CROSS-REFERENCE TO RELATED APPLICATIONS

This application claims the priority of Korean Patent Application No. 2005-0038963, filed on May 10, 2005, in the Korean Intellectual Property Office, the disclosure of which is incorporated herein by reference.

### BACKGROUND OF THE INVENTION

1. Field of the Invention

The present invention relates to a plasma display panel. More particularly, the present invention relates to a plasma display panel which has improved sealing performance and connectivity with external circuits.

2. Description of the Related Technology

Generally, a plasma display device refers to a flat panel display device using a plasma display panel (PDP; hereinafter, a plasma display panel can also be referred to as a panel). A plasma display panel can be formed by forming electrodes on each of two opposite substrates, overlapping the substrates with each other such that a predetermined space is formed between the substrates, injecting discharge gas into the space, and sealing the space. Then, the plasma display panel is connected to components for providing signals for displaying an image. For example, driving circuits are connected to the electrodes of the plasma display panel.

Unlike a bulky and heavy cathode ray tube (CRT) device, a plasma display device can be configured to have a slim structure and a light weight. Thus, a plasma display device is suitable for a large-sized screen display device. In addition, unlike other flat panel display devices such as LCDs, a plasma display device does not require an active element such as a transistor. Furthermore, a plasma display device provides wide viewing angles and superior brightness.

Typically, a plurality of pixels are aligned in a plasma display panel in the form of a matrix for displaying an image. In the plasma display panel, each pixel can be driven by simply applying a voltage to each pixel electrode through a passive matrix scheme without employing an active element.

A plasma display panel can be classified into a DC type plasma display panel and an AC type plasma display panel according to the voltage signal used for driving electrodes. In addition, a plasma display panel can be classified into an opposite discharge type plasma display panel and a surface discharge type plasma display panel according to the alignment of a pair of electrodes to which the discharge voltage is applied.

In an AC type plasma display panel, an electrode is covered with a dielectric layer. Thus, the electrode naturally has capacitance and a current applied to the electrode is limited. The electrode, however, is protected from ion bombardment during the discharge operation. As a result, the life span of the electrode may be lengthened. In the case of a typical AC surface discharge type plasma display panel, a plurality of address electrodes are vertically arranged in parallel to each other and embedded in one of two substrates Display electrodes and scanning electrodes, which are commonly referred to as “sustain electrodes,” are horizontally and alternately aligned in parallel to each other and embedded in the same or the other substrate.

The display electrodes are commonly connected to one lateral side of the panel. When a cell forming a pixel is viewed from above, one vertical electrode (address electrode) and two horizontal electrodes (scanning and display electrodes) intersect with each other. In a top emission type plasma display device, a sustain electrode of a cell is formed of a transparent material such that the sustain electrode does not interfere with the light path. A bus electrode having superior conductivity and a narrow width is connected to the transparent electrode in a row.

An arrangement of pixels which can be called “matrix” can be made by arranging barrier ribs and electrodes. The barrier ribs can be aligned in the form of a striped matrix pattern in which the barrier ribs are linearly aligned parallel to the address electrodes in the form of columns. The barrier ribs can also be arranged in a grid matrix pattern in which the barrier ribs are aligned vertically and horizontally in columns and rows, thereby defining cells.

Referring to FIGS. 1A and 1B, a conventional plasma display panel will be described below. The conventional plasma display panel includes a rear panel 10, a front panel 20 and an intermediate member 30 interposed between the rear panel 10 and the front panel 20. In general, the rear panel 10 and the front panel 20 are securely bonded to each other by using a sealant 40 formed of a glass having a low melting point called a “frit glass”.

The rear panel 10 generally includes an insulating substrate, a plurality of address electrodes, and an insulating layer. The plurality of address electrodes are formed on a surface of the insulating substrate which faces the front panel 20. The address electrodes are aligned in parallel to each other and are spaced apart from each other. The insulating layer is formed over the surface of the insulating substrate and the address electrodes.

The front panel 20 has an insulating substrate. In addition, the front panel 20 can have an insulating layer on a surface facing the rear panel 10.

The intermediate member 30 is interposed between the rear panel 10 and the front panel 20. The intermediate member 30 is configured to serve as a barrier wall. The intermediate member 30 has a grid structure having a plurality of cells. The plurality of cells are defined by a plurality of first directional components 31 aligned parallel to each other and a plurality of second directional components 32 aligned parallel to each other while crossing the first directional components 31. In addition, sustain electrodes are buried in the first directional components 31 or the second directional components 32, whichever crosses the address electrodes.

In the plasma display panel of FIG. 1A, the sealant 40 is formed around the intermediate member 40 after the intermediate member 30 has been interposed between the rear panel 10 and the front panel 20 and the rear panel 10, and the front panel 20 have been pressed against each other such that the plasma display panel can be sealed. However, although such a plasma display panel can be easily assembled, it is difficult to extend electrode terminals from the intermediate member 30 to the outside of the panel.

### SUMMARY OF CERTAIN INVENTIVE ASPECTS

One aspect of the invention provides a plasma display panel. The plasma display panel comprises: a front panel; a rear panel; an intermediate member interposed between the front and the rear panels; at least one sealant configured to seal at least one space between the front and the rear panels; address electrodes; and sustain electrodes configured to cross the address electrodes, wherein the intermediate member comprises a plurality of dielectric layers, wherein each of the dielectric layers comprises a plurality of first directional components, a plurality of second directional components configured to cross the first directional components, and an edge part surrounding the first and the second directional components, and wherein widths of the edge parts of the dielectric layers are configured to be different from each other.

In the plasma display panel, the intermediate member may comprise a first dielectric layer facing the front panel and a second dielectric layer facing the rear panel; wherein the address electrodes are formed on one of the front panel and the rear panel, and wherein the sustain electrodes are interposed between the first and the second dielectric layers. A sealant may be formed between the edge part of the first dielectric layer and the front panel, and another sealant may be formed between the edge part of the second dielectric layer and the rear panel. The sealant may comprise a frit glass.

The edge part of the second dielectric layer may have a width larger than a width of the edge part of the first dielectric layer. A width difference between the edge parts of the first and the second dielectric layers may range from about 5 mm to about 8 mm. The sustain electrodes may be configured to be exposed outside of the plasma display panel. The sustain electrodes may be exposed to an extent corresponding to a width difference between the edge parts of the first and the second dielectric layers.

The intermediate member may comprise a first, a second, and a third dielectric layers, the dielectric layers being sequentially stacked in a direction from the front panel to the rear panel. The sustain electrodes may be interposed between the first dielectric layer and the second dielectric layer. The address electrodes may be interposed between the second dielectric layer and the third dielectric layer.

A sealant may be formed between the edge part of the first dielectric layer and the front panel, and another sealant may be formed between the edge part of the third dielectric layer and the rear panel. The third dielectric layer may have a largest width and the first dielectric layer may have a smallest width among the first to third dielectric layers.

A width difference between the edge parts of the first and second dielectric layers may be in a range of about 5 mm to about 8 mm, and a width difference between the edge parts of the second and third dielectric layers may be in a range of about 5 mm to about 8 mm. Each of the first, second, and third dielectric layers may comprise a frit glass. The sustain electrodes may be configured to be exposed outside of the plasma display panel. The sustain electrodes may be configured to be exposed to an extent corresponding to a width difference between the edge parts of the first and the second dielectric layers. The address electrodes may be configured to be exposed to the outside of the plasma display panel. The address electrodes may be configured to be exposed to an extent corresponding to a width difference between the edge parts of the second and the third dielectric layers.

Another aspect of the invention provides a plasma display panel. The plasma display device comprises: a front panel; a rear panel; an intermediate member interposed between the front and the rear panels; a sealant for sealing a space between the front and the rear panels; address electrodes; and sustain electrodes configured to cross the address electrodes. The intermediate member comprises at least one dielectric layer. The dielectric layer comprises a plurality of first directional components, a plurality of second directional components configured to cross the first directional components, and an edge part surrounding the first and the second directional components. The sealant is formed on the surface of the edge part.

In the plasma display panel, the intermediate member may comprise one dielectric layer; wherein the sustain electrodes are formed on the dielectric layer; wherein a width of the front panel along the sustain electrode may be smaller than a width of the dielectric layer so that at least one end portion of the sustain electrode extends beyond the front panel; and wherein an outer periphery of the front panel may be positioned within the edge part of the dielectric layer when viewed from a direction perpendicular to the plasma display panel.

Yet another aspect of the invention provides a plasma display device comprising the plasma display panel described above.

Another aspect of the invention provides a plasma display panel which has improved sealing performance. The plasma display panel comprises: a front panel; a rear panel; an intermediate member interposed between the front and rear panels; a sealant for sealing a space formed between the front and rear panels; and address and sustain electrodes crossing each other, wherein the intermediate member includes at least one dielectric layer, the dielectric layer includes a plurality of first directional components, a plurality of second directional components crossing the first directional components, and an edge part surrounding the first and second directional components, and the sealant is aligned within a width of the edge part when viewed from a direction perpendicular to the plasma display panel.

According to one exemplary embodiment of the invention, the intermediate member includes one dielectric layer, the sustain electrodes are formed on the dielectric layer, and a width of the front panel in a length direction of the sustain electrode is smaller than a width of the dielectric layer so that at least one end portion of the sustain electrode extends beyond the front panel and is positioned within the edge part of the dielectric layer when viewed from a direction perpendicular to the plasma display panel.

According to another aspect of the invention, there is provided a plasma display panel comprising: a front panel; a rear panel; an intermediate member interposed between the front and rear panels; a sealant for sealing a space formed between the front and rear panels; and address and sustain electrodes crossing each other, wherein the intermediate member includes a plurality of dielectric layers, each of the dielectric layer includes a plurality of first directional components, a plurality of second directional components crossing the first directional components, and an edge part surrounding the first and second directional components, and widths of edge parts of the dielectric layers are different from each other.

According to one exemplary embodiment of the invention, the intermediate member includes first and second dielectric layers, the address electrodes are formed on the front panel or the rear panel, and the sustain electrodes are interposed between the first and second dielectric layers.

The sealant may be formed along the edge part of the first or second dielectric layer facing the rear panel and/or along the edge part of the first or second dielectric layer facing the front panel.

The sealant may be a frit glass made from glass having a low melting point.

The edge part of the first or second dielectric layer adjacent to the rear panel may have a width larger than a width of the edge part of the first or second dielectric layer adjacent to the front panel. Preferably, the edge part of the first or second dielectric layer adjacent to the rear panel has the width larger than the width of the edge part of the first or second dielectric layer adjacent to the front panel by 5 to 8 mm.

The sustain electrodes are exposed to an exterior to an extent corresponding to a width difference between edge parts of the first and second dielectric layers so as to be connected to external circuits.

The intermediate member may include first, second and third dielectric layers, which are sequentially stacked in a direction from the front panel to the rear panel, the address electrodes are interposed between the second and third dielectric layers, and the sustain electrodes are interposed between the first and second dielectric layers.

The sealant may be formed along the edge part of the surface of the first, second or third dielectric layer facing the front panel and along the edge part of the surface of the first, second or third dielectric layer facing the rear panel.

The third dielectric layer may have a largest width and the first dielectric layer has a smallest width among the first to third dielectric layers.

A width difference between edge parts of the first and second dielectric layers is in a range of about 5 to 8 mm, and a width difference between edge parts of the second and third dielectric layers is in a range of about 5 to 8 mm.

The sustain electrodes are exposed to an exterior to an extent corresponding to a width difference between edge parts of the first and second dielectric layers and the address electrodes are exposed to the exterior to an extent corresponding to a width difference between edge parts of the second and third dielectric layers so as to be connected to external circuits.

### BRIEF DESCRIPTION OF THE DRAWINGS

Aspects and advantages of the invention will become apparent and more readily appreciated from the following description, taken in conjunction with the accompanying drawings.

FIGS. 1A and 1B are a schematic cross-sectional and a plan view, respectively, of a conventional plasma display panel;

FIGS. 2A and 2B are a schematic cross-sectional and a plan view, respectively, of a comparative example of plasma display panel;

FIG. 3 is a schematic exploded perspective view illustrating a plasma display panel according to one embodiment of the invention;

FIG. 4A is a schematic cross-sectional view illustrating a plasma display panel according to one embodiment of the invention;

FIG. 4B is a schematic perspective view illustrating an intermediate member of a plasma display panel according to one embodiment of the invention;

FIG. 5A is a schematic cross-sectional view illustrating a plasma display panel according to another embodiment of the invention;

FIG. 5B is a schematic perspective view illustrating an intermediate member of a plasma display panel according to another embodiment of the invention;

FIG. 6A is a schematic cross-sectional view illustrating a plasma display panel according to still another embodiment of the invention; and

FIG. 6b is a schematic perspective view illustrating an intermediate member of a plasma display panel according to still another embodiment of the invention.

### DETAILED DESCRIPTION OF CERTAIN INVENTIVE EMBODIMENTS

Plasma display panels according to embodiments of the invention will be described in detail with reference to the accompanying drawings. In the drawings, like reference numerals indicate identical or functionally similar elements.

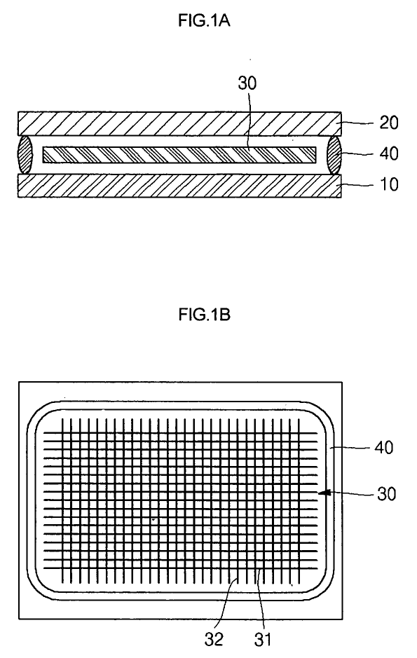

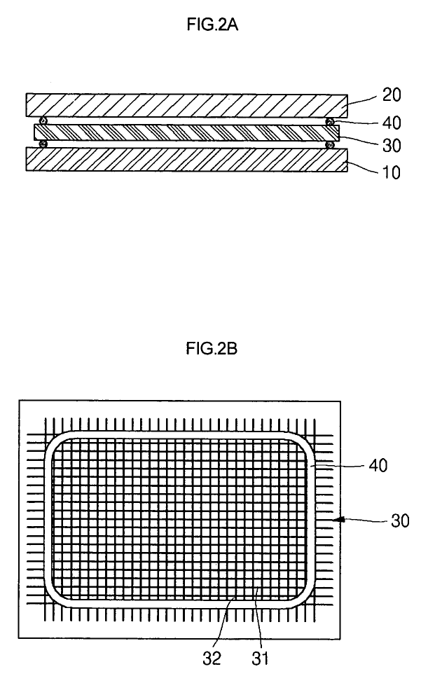

In order to solve the problems of the conventional plasma display device as shown in FIGS. 1A and 1B, a type of plasma display panel has been proposed as shown in FIGS. 2A and 2B. According to the plasma display device shown in FIGS. 2A and 2B, a sealant 40 formed of frit glass is formed on outer peripheral portions of first and second directional components 31 and 32 of an intermediate member 30. The sealant is formed after the intermediate member 30 has been interposed between a rear panel 10 and a front panel 20, and then the rear panel 10 and the front panel 20 have been pressed against each other such that the plasma display device can be sealed. However, in the above plasma display panel, the sealant 40 may have an irregular thickness due to structural irregularities of the intermediate member 30. Thus, the sealant 40 has a residual stress after the sealing process has been completed. This problem degrades sealing performance of the plasma display panel.

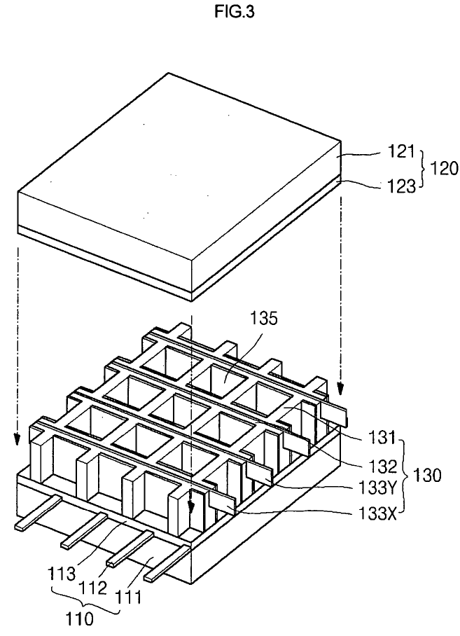

FIG. 3 is an exploded perspective view illustrating a plasma display panel according to one embodiment of the invention. The plasma display panel includes a rear panel 110, a front panel 120, and an intermediate member 130. The front panel 120 is aligned opposite to the rear panel 110. The intermediate member 130 is interposed between the rear panel 110 and the front panel 120 and is in the form of a grid structure. In addition, a fluorescent layer (not shown) may be formed on at least one of the rear and front panels 110 and 120. For instance, a fluorescent layer may be formed on the rear panel 110, facing the front panel 120.

The rear panel 110 and the front panel 120 have insulating substrates 111 and 121, respectively. In addition, the rear panel 110 and the front panel 120 can also have insulating layers 113 and 123, respectively, which are opposite to each other.

The intermediate member 130 has a grid structure defined by a plurality of first directional components 131 aligned parallel to each other and a plurality of second directional components 132 aligned parallel to each other. The second directional components 132 cross the first directional components 131, thereby forming a plurality of cells 135. In certain embodiments, the intermediate member 130 can be integrally formed with the rear panel 110 or the front panel 120. In addition, the intermediate member 130 may be formed of a frit glass. An exemplary glass is frit glass. However, any other suitable material can be used for the intermediate member 130.

The illustrated plasma display panel also includes address electrodes 112 and sustain electrode pairs 133X and 133Y. The address electrodes 112 and the sustain electrode pairs 133X and 133Y can be arranged in various patterns. For instance, a plurality of address electrodes 112 may be aligned on either the insulating substrate 111 of the rear panel 110 or the insulating substrate 121 of the front panel 120. In FIG. 3, the address electrodes 112 are formed on the insulating substrate 111 of the rear panel 110. The address electrodes 112 are spaced apart from each other at a predetermined interval. In addition, the sustain electrode pairs 133X and 133Y may be buried in the first directional components 131 or the second directional components 132 of the intermediate member 130, which cross the address electrodes 112. In the illustrated embodiment, the sustain electrode pairs 133X and 133Y are buried in the second directional components 132 of the intermediate member 130. Thus, the sustain electrode pairs 133X and 133Y cross the address electrodes 112.

In other embodiments, the address electrodes 112 and the sustain electrode pairs 133X and 133Y can be buried in the intermediate member 130. The address electrodes 112 may be buried in either the first directional components 131 or the second directional components 132 of the intermediate member 130. In one embodiment, the address electrodes 112 are buried in the first directional components 131 of the intermediate member 130. In this embodiment, the sustain electrode couples 133X and 133Y are buried in the second directional components 132 of the intermediate member 130 so that they cross the address electrodes 112.

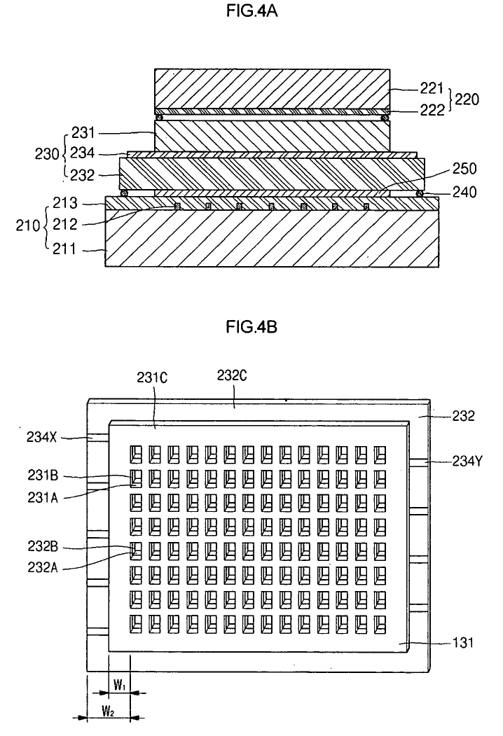

FIG. 4A is a schematic cross-sectional view illustrating a plasma display panel according to another embodiment of the invention. FIG. 4B is a perspective view illustrating the intermediate member of the plasma display panel of FIG. 4A.

The plasma display panel of FIGS. 4A and 4B includes a rear panel 210, a front panel 220, and an intermediate member 230. The front panel 220 is arranged opposite to the rear panel 210. The intermediate member 230 is interposed between the rear panel 210 and the front panel 220 and is in the form of a grid structure. In addition, sealants 240 are formed on outer peripheral portions of the intermediate member 230 in order to seal the plasma display panel. The sealants 240 are provided on both top and bottom surfaces of the intermediate member 230. The sealants 240 are configured to seal spaces between the intermediate member 230 and the rear panel 210 and between the intermediate member 230 and the front panel 220.

In the illustrated embodiment, a fluorescent layer 250 is formed on at least one of the rear and front panels 210 and 220. In one embodiment, the fluorescent layer 250 is formed on an insulating layer 213 of the rear panel 210. The sealants 240 are formed of a glass having a low melting point called “frit glass” or the like. However, any suitable material can also be used for the sealants 240.

In the illustrated embodiment, the rear panel 210 includes an insulating substrate 211, a plurality of address electrodes 212, and the insulating layer 213. The address electrodes 212 are formed over the insulating substrate 211 and are spaced apart from each other at a predetermined interval. The insulating layer 213 is formed over the insulating substrate 211 and the address electrodes 212. The insulating layer 213 is configured to face the intermediate member 230. In one embodiment, the insulating substrate 211 is formed of glass. In addition, although not illustrated in FIGS. 4A and 4B, a protective layer may also be formed over the insulating layer 213. In one embodiment, the protective layer is formed of MgO.

In the illustrated embodiment, the front panel 220 has an insulating substrate 221. The front panel 220 may also have an insulating layer 222. The insulating layer 22 is formed on the bottom surface of the insulating substrate 221, facing the intermediate member 230.

The intermediate member 230 includes a first dielectric layer 231, a second dielectric layer 232, and sustain electrode pairs 234, including 234X and 234Y as shown in FIG. 4B. The sustain electrode pairs are interposed between the first and second dielectric layers 231 and 232.

The first and second dielectric layers 231 and 232 are formed of a glass having a lower melting point than that of the rear or front panel. The first dielectric layer 231 includes first directional components 231A and second directional components 231B crossing the first directional components 231A. In addition, the second dielectric layer 232 includes first directional components 232A and second directional components 232B crossing the first directional components 232A. Edge parts 231C and 232C having predetermined widths are provided at peripheral portions of the first and second dielectric layers 231 and 232, respectively. The edge parts 231C and 232C surround the first and second directional components 231A, 232A, 231B and 232B of the first and second dielectric layers 231 and 232.

In one embodiment, cavities are formed in the first dielectric layer 231 by the first and second directional components 231A and 231B. These cavities correspond to cavities formed in the second dielectric layer 232 by the first and second directional components 232A and 232B. The cavities may serve as discharge cells in which the plasma discharge is generated.

In addition, the sustain electrode pairs 234 (234X and 234Y) are interposed between the first and second dielectric layers 231 and 232 such that they cross the address electrodes 212 of the rear panel 210.

The sealants 240 are formed of a glass having a lower melting point than that of dielectric layers. The sealants 240 are formed between the edge part 231C of the first dielectric layer 231 and the front panel 220 and between the edge part 232C of the second dielectric layer 232 and the rear panel 210. The sealants 240 integrally combine the rear panel 210, the front panel 220 and the intermediate member 230. They are configured to seal spaces between the intermediate member 230 and the rear panel 210 and between the intermediate member 230 and the front panel 220.

Referring to FIG. 4B, in one embodiment, the edge parts 231C and 232C of the first and second dielectric layers 231 and 232 may have widths different from each other. In the illustrated embodiments, the width of the edge part 232C of the dielectric layer 232 directly over the rear panel 210 is larger than the width of the edge part 231C of the dielectric layer 231 directly below the front panel 210. In other words, the width W₂ of the edge part 232C of the second dielectric layer 232 is larger than the width W₁ of the edge part 231C of the first dielectric layer 231.

In one embodiment, a width difference (W₂-W₁) between the edge parts 232C and 231C of the second and first layers 232 and 231 ranges from about 5 mm to about 8 mm. In this embodiment, end portions of the sustain electrode pairs 234X and 234Y are exposed to the exterior of the plasma display panel. In other words, the sustain electrode pairs 234X and 234Y are exposed from the stack to an extent corresponding to the width difference (W₂-W₁) between the edge parts 232C and 231C of the second and first dielectric layers 232 and 231. Thus, the sustain electrode pairs 234X and 234Y can be easily connected through the exposed portions to external circuits such as a flexible printed circuit board (FPC), a printed circuit board (PCB), etc.

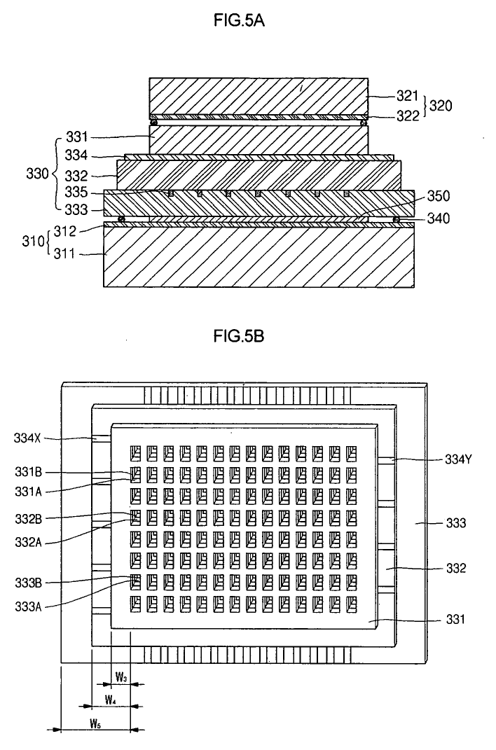

FIG. 5A is a schematic cross-sectional view illustrating a plasma display panel according to another embodiment. FIG. 5B is a perspective view illustrating the intermediate member of the plasma display panel of FIG. 5A.

Referring to FIGS. 5A and 5B, the plasma display panel includes a rear panel 310, a front panel 320, and an intermediate member 330. The front panel 320 is arranged in opposite to the rear panel 310. The intermediate member 330 is interposed between the rear panel 310 and the front panel 320 and is in the form of a grid structure. In addition, sealants 340 are formed on upper and lower outer peripheral portions of the intermediate member 330 in order to seal the plasma display panel. In addition, a fluorescent layer may be provided on at least one of the rear panel 310 and the front panel 320. In the illustrated embodiment, the fluorescent layer 350 is formed on an insulating layer of the rear panel 310.

The rear panel 310 and the front panel 320 may include insulating substrates 311 and 321, respectively. In addition, the rear panel 310 and the front panel 320 can have insulating layers 312 and 322. The insulating layers 312 and 322 are formed on the insulating substrates 311 and 321, respectively, in opposite to each other.

The intermediate member 330 may include a first dielectric layer 331, a second dielectric layer 332, and a third dielectric layer 333, which are sequentially stacked in a direction from the front panel 320 to the rear panel 310. In addition, the intermediate member 330 may further includes sustain electrode pairs 334 interposed between the first and second dielectric layers 331 and 332. The intermediate member 330 may also include address electrodes 335 interposed between the second and third dielectric layers 332 and 333.

The first to third dielectric layers 331, 332 and 333 are formed of a glass having a low melting point. The first dielectric layer 331 includes first directional components 331A and second directional components 331B crossing the first directional components 331A. The second dielectric layer 332 includes first directional components 332A and second directional components 332B crossing the first directional components 332A. In addition, the third dielectric layer 333 includes first directional components 333A and second directional components 333B crossing the first directional components 333A. Edge parts 331C, 332C, and 333C having predetermined widths are provided at peripheral portions of the first, second, and third dielectric layers 331, 332, and 333, respectively. The edge parts 331C, 332C, and 333C surround the first and second directional components 331A, 332A, 333A, 331B, 332B and 333B, respectively.

In one embodiment, cavities are formed in the first to third dielectric layer 331 to 333, respectively, by the first and second directional components 331A, 332A, 333A, 331B, 332B and 333B of the three dielectric layers. The cavities in one of the layers correspond to those in the other layers. The cavities may serve as discharge cells in which the plasma discharge is generated.

In the illustrated embodiment, the sustain electrode pairs 334 are interposed between the first and second dielectric layers 331 and 332. The address electrodes 335 are interposed between the second and third dielectric layers 332 and 333. In this embodiment, the sustain electrode pairs 334X and 334Y are aligned parallel to either the first directional components 331A and 332A of the first and second dielectric layers 331 and 332 or the second directional components 331B and 332B of the first and second dielectric layers 331 and 332. In addition, the address electrodes 335 are aligned parallel to either the first directional components 332A and 333A of the second and third dielectric layers 332 and 333 or the second directional components 332B and 333B of the second and third dielectric layers 332 and 333 such that the address electrodes 335 can cross the sustain electrode pairs 334X and 334Y.

The sealants 340 are formed between the edge part 331C of the first dielectric layer 331 and the front panel 320 and between the edge part 333C of the third dielectric layer 333 and the rear panel 310. The sealants 340 integrally combine the rear panel 310, the front panel 320 and the intermediate member 330. The sealants are configured to seal spaces formed between the intermediate member 330 and the rear panel 310 and between the intermediate member 330 and the front panel 320.

Referring to FIG. 5B, in one embodiment, a width W₅ of the edge part 333C of the third dielectric layer 333 is larger than a width W₃ of the first dielectric layer 331 or a width W₄ of the second dielectric layer 332. In addition, the width W₃ of the edge part 331C of the first dielectric layer 331 is smaller than the width W₄ of the second dielectric layer 332 or the width W₅ of the third dielectric layer 333. That is, among the first to third dielectric layers 331 to 333, the edge part of the dielectric layer directly over the rear panel 310 has the largest width and the edge part of the dielectric layer directly below the front panel 320 has the smallest width.

In one embodiment, a width difference (W₄-W₃) between the edge parts 332C and 331C of the second and first dielectric layers 332 and 331, respectively, ranges from about 5 mm to about 8 mm. A width difference (W₅-W₄) between the edge parts 333C and 332C of the third and second dielectric layers 333 and 332, respectively, ranges from about 5 mm to about 8 mm. In this embodiment, end portions of the sustain electrode pairs 334X and 334Y and the address electrodes 335 are exposed to the outside of the plasma display panel so that the electrodes 334X, 334Y, and 335 are easily connected to external circuits. Examples of external circuits include a flexible printed circuit board (FPC) and a printed circuit board (PCB). In other words, the sustain electrode couples 334(334X and 334Y) are exposed to the outside to an extent corresponding to the width difference (W₄-W₃) between the edge parts 332C and 331C of the second and first dielectric layers 332 and 331. In addition, the address electrodes 335 are exposed to the outside to an extent corresponding to the width difference (W₅-W₄) between the edge parts 333C and 332C of the third and second dielectric layers 333 and 332. Thus, the sustain electrode couples 334(334X and 334Y) and the address electrodes 335 can be connected to the external circuits through the exposed portions.

As described above with respect to the embodiments of the invention, the intermediate member 230 or 330 includes the first and second dielectric layers 231 and 232, or the first to third dielectric layers 331 to 333 in the form of a grid structure. In addition, the first and second dielectric layers 231 and 232 include the first and second directional components 231A, 232A, 231B and 232B and the edge parts 231C and 232C surrounding the first and second directional components 231A, 232A, 231B and 232B, respectively. The first to third dielectric layers 331 to 333 may include the first and second directional components 331A, 332A, 333A, 331B, 332B and 333B and the edge parts 331C, 332C and 333C surrounding the first and second directional components 331A, 332A, 333A, 331B, 332B and 333B, respectively. Furthermore, the sealants 240 or 340 are provided on the edge parts 231C and 232C or the edge parts 331C, 332C and 333C in order to seal the spaces between the intermediate member 230 and 330 and rear panels 220 and 320 and between the intermediate member 230 and 330 and the front panels 210 and 310. These configurations prevent sealing degradation due to an irregular thickness of the sealants 240 or 340 resulting from the structural irregularities of the intermediate member 230 or 330.

In addition, the edge parts 231C and 232C of the first and second dielectric layers 231 and 232 or the edge parts 331C, 332C and 333C of the first to the third dielectric layers 331 to 333 are configured to have different widths W₁ and W₂,or W₃, W₄ and W₅, from one another. Thus, the sustain electrode couples 234 or 334 and address electrodes 212 or 335 are exposed to the outside of the plasma display panel and thus can be easily connected to external circuits.

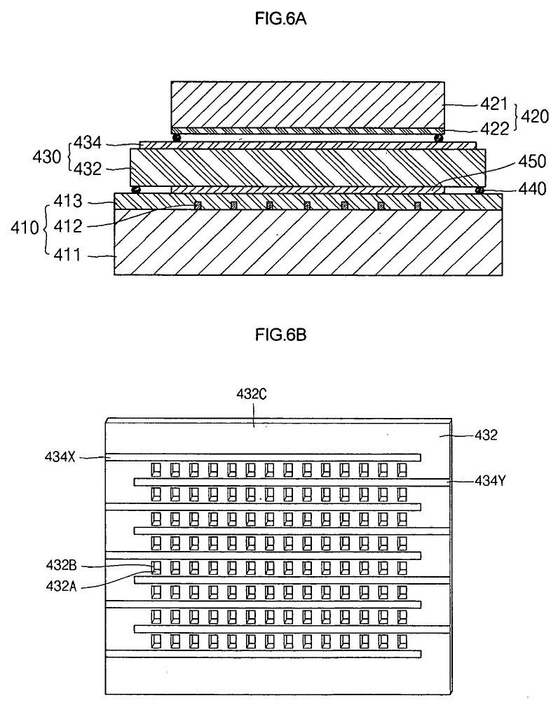

FIG. 6A is a schematic cross-sectional view of a plasma display panel according to another embodiment in which an intermediate member has a single dielectric layer. FIG. 6B is a perspective view illustrating the plasma display panel of FIG. 6A.

The plasma display panel of FIGS. 6A and 6B will be described below in comparison with the plasma display panel of FIGS. 4A and 4B. Unlike the intermediate member 230 of FIGS. 4A and 4B, an intermediate member 430 of FIGS. 6A and 6B has a single dielectric layer 432. Thus, the structure of the plasma display panel of FIG. 6A is simpler than that of FIG. 4A. Thus, the intermediate member 430 can be easily fabricated.

Referring to FIG. 6B, the intermediate member 430 has only one dielectric layer 432. Sustain electrodes 434X and 434Y may be formed on the dielectric layer 432. The dielectric layer 432 of the intermediate member 430 may also include a first and a second directional components 432A and 432B and an edge part 432C. The edge part 432C has a predetermined width and surrounds the first and second directional components 432A and 432B. End portions of the sustain electrodes 434X and 434Y may be positioned on the edge part 432C of the dielectric layer 432 such that the sustain electrodes 434X are exposed to the outside of the plasma display panel. Then, the sustain electrodes 434Y can be easily connected to an external circuit.

In addition, sealants 440 are provided on the rear and the front surface of the dielectric layer 432 on the edge part 432C of the dielectric layer 432. The sealants 440 are configured to seal spaces between the dielectric layer 432 and the front panel 420 and between the dielectric layer 432 and the rear panel 410. The length of the front panel 420 along the sustain electrode 434 is shorter than that of the dielectric layer 432 so that at least one end portion of the sustain electrode extends beyond the front panel 420. An outer periphery of the front panel 420 is positioned within the edge part 432C of the dielectric layer 432 when viewed from a direction perpendicular to the plasma display panel. As described above, the embodiments of the invention can provide plasma display panels having improved sealing performance.

Although various embodiments of the invention have been shown and described, it will be appreciated by those technologists in the art that changes might be made in these embodiments without departing from the principles and spirit of the invention, the scope of which is defined in the claims and their equivalents.

What is claimed is:

1. A plasma display panel comprising:
a front panel;
a rear panel;
an intermediate member interposed between the front and the rear panels;
at least one sealant configured to seal at least one space between the front and the rear panels;
address electrodes; and
sustain electrodes configured to cross the address electrodes,
wherein the intermediate member comprises a plurality of dielectric layers,
wherein each of the dielectric layers comprises a plurality of first directional components, a plurality of second directional components configured to cross the first directional components, and an edge part surrounding the first and the second directional components, and
wherein widths of the edge parts of the dielectric layers are configured to be different from each other.

2. The plasma display panel of claim 1, wherein the intermediate member comprises a first dielectric layer facing the front panel and a second dielectric layer facing the rear panel;
wherein the address electrodes are formed on one of the front panel and the rear panel, and
wherein the sustain electrodes are interposed between the first and the second dielectric layers.

3. The plasma display panel of claim 2, wherein a sealant is formed between the edge part of the first dielectric layer and the front panel, and wherein another sealant is formed between the edge part of the second dielectric layer and the rear panel.

4. The plasma display panel of claim 1, wherein the sealant comprises a frit glass.

5. The plasma display panel of claim 2, wherein the edge part of the second dielectric layer has a width larger than a width of the edge part of the first dielectric layer.

6. The plasma display panel of claim 5, wherein a width difference between the edge parts of the first and the second dielectric layers ranges from about 5 mm to about 8 mm.

7. The plasma display panel of claim 2, wherein the sustain electrodes are configured to be exposed outside of the plasma display panel.

8. The plasma display panel of claim 7, wherein the sustain electrodes are exposed to an extent corresponding to a width difference between the edge parts of the first and the second dielectric layers.

9. The plasma display panel of claim 1, wherein the intermediate member comprises a first, a second, and a third dielectric layers, the dielectric layers being sequentially stacked in a direction from the front panel to the rear panel;
wherein the sustain electrodes are interposed between the first dielectric layer and the second dielectric layer; and
wherein the address electrodes are interposed between the second dielectric layer and the third dielectric layer.

10. The plasma display panel of claim 9, wherein a sealant is formed between the edge part of the first dielectric layer and the front panel, and wherein another sealant is formed between the edge part of the third dielectric layer and the rear panel.

11. The plasma display panel of claim 9, wherein the third dielectric layer has a largest width and the first dielectric layer has a smallest width among the first to third dielectric layers.

12. The plasma display panel of claim 9, wherein a width difference between the edge parts of the first and second dielectric layers is in a range of about 5 mm to about 8 mm, and wherein a width difference between the edge parts of the second and third dielectric layers is in a range of about 5 mm to about 8 mm.

13. The plasma display panel of claim 9, wherein each of the first, second, and third dielectric layers comprises a frit glass.

14. The plasma display panel of claim 9, wherein the sustain electrodes are configured to be exposed outside of the plasma display panel.

15. The plasma display panel of claim 14, wherein the sustain electrodes are configured to be exposed to an extent corresponding to a width difference between the edge parts of the first and the second dielectric layers.

16. The plasma display panel of claim 9, wherein the address electrodes are configured to be exposed to the outside of the plasma display panel.

17. The plasma display panel of claim 16, wherein the address electrodes are configured to be exposed to an extent corresponding to a width difference between the edge parts of the second and the third dielectric layers.

18. A plasma display panel comprising:
a front panel;
a rear panel;
an intermediate member interposed between the front and the rear panels;
a sealant for sealing a space between the front and the rear panels;
address electrodes; and
sustain electrodes configured to cross the address electrodes,
wherein the intermediate member comprises at least one dielectric layer;
wherein the dielectric layer comprises a plurality of first directional components, a plurality of second directional components configured to cross the first directional components, and an edge part surrounding the first and the second directional components; and
wherein the sealant is formed on the surface of the edge part.

19. The plasma display panel of claim 18, wherein the intermediate member comprises one dielectric layer;
wherein the sustain electrodes are formed on the dielectric layer;
wherein a width of the front panel along the sustain electrode is smaller than a width of the dielectric layer so that at least one end portion of the sustain electrode extends beyond the front panel; and
wherein an outer periphery of the front panel is positioned within the edge part of the dielectric layer when viewed from a direction perpendicular to the plasma display panel.

20. A plasma display device comprising the plasma display panel of claim 1.
